(19) United States
(12) Patent Application Publication
(10) Pub. No.: US 2019/0318652 A1
(43) Pub. Date: Oct. 17, 2019

(54) USE OF INTELLIGENT SCAFFOLDING TO TEACH GESTURE-BASED INK INTERACTIONS

(71) Applicant: Microsoft Technology Licensing, LLC, Redmond, WA (US)

(72) Inventors: Elise LIVINGSTON, Seattle, WA (US); Adam Samuel RIDDLE, Seattle, WA (US); Allison SMEDLEY, Issaquah, WA (US); Robin TROY, Redmond, WA (US)

(21) Appl. No.: 15/953,101

(22) Filed: Apr. 13, 2018

(51) Int. Cl. G09B 19/00; G06N 99/00; G09B 5/02; G06K 9/00; G06F 3/0488

(52) U.S. Cl. CPC G09B 19/0053; G06N 99/005; G06F 3/04883; G06K 9/00416; G09B 5/02

(57) ABSTRACT

Various embodiments of the present technology relate to digital inking technology. More specifically, some embodiments relate to use of intelligent scaffolding to teach gesture-based ink interactions. For example, in some embodiments telemetry data on user interactions with a user interface to an application can be collected at a client device. The telemetry data can be analyzed to identify user proficiency with a digital inking gesture. Upon determining a low user proficiency with the digital inking gesture, user interactions resembling a digital inking gesture within the application can be identified. A training interface can be automatically surfaced, on a display of the client device, with specifically scoped training information on the digital inking gesture to improve the user proficiency with the digital inking gesture.

### BACKGROUND

Digital inking has become a popular feature in many software applications. In many instances, a canvas is provided in a user interface to an application through which a user may supply inking input by away of a stylus, mouse, or touch gestures. The inking capabilities provide the user with an easy and natural way to interact with the application. Increasingly users are experiencing inking capabilities as the prevalence of touch screens and digital pens within electronic devices continue to grow. Moreover, the inking capabilities continue to expand within various applications.

For example, some applications allow a user to insert typewritten text based on hand drawn words created with digital inking that is then automatically translated into typed text. In addition, words or paragraphs can be deleted with a strikethrough generated by the digital ink. As additional examples, digital inking can be used to find and replace words, insert comments, group a discontinuous set of objects that can each be individually selected, manipulated, or otherwise interacted with, and many other features. As additional intelligence and power are added to the capability of digital inking features within applications, more gestures and new ways of interacting with content is created. Unfortunately, the number and complexity of digital inking gestures make can make learning and remembering difficult for users.

Traditionally, users have relied upon help documentation. This method of learning, however, can be cumbersome and time consuming For example, interactions with such documentation may take the user out of a creative flow by requiring a shift of focus and unnecessary searching. As such, there is a need for improved systems and techniques to show user available ink gestures available to them in and efficient and timely way.

### OVERVIEW

Various embodiments of the present technology relate to digital inking technology. More specifically, some embodiments relate to use of intelligent scaffolding to teach gesture-based ink interactions. For example, in some embodiments data on user interactions (e.g., keyboard interactions, mouse interactions, inking gestures, and digital pen interactions) with a user interface to an application can be collected at a client device. The data can be analyzed to identify user proficiency (e.g., skill or ability) with a digital inking gesture. Upon determining a low user proficiency (e.g., unrecognized gestures, gestures followed by undo requests, transition back into other editing modes, slow or below average gesture speed, use of a limited set of gestures, etc.) with the digital inking gesture, user interactions resembling a digital inking gesture within the application can be identified. A training interface can be automatically surfaced, on a display of the client device, with specifically scoped training information on the digital inking gesture to improve the user proficiency with the digital inking gesture. In some embodiments, recorded interactions with the user interface can be transmitted to a cloud-based data repository to be ingested by a machine learning system. The user interactions can be ingested, along with other telemetry data and interactions from multiple other user interfaces, to determine rules regarding when to render the user interface that can be pushed out to the various instances of the application.

For example, in some embodiments, the data may record user interactions with the user interface that include repeated inking gestures followed by undo requests. Various embodiments can detect this pattern of interaction and analyze the repeated inking gestures to identify actual inking gestures supported by the application that are similar to the repeated inking gestures. Once the actual inking gestures are identified, training information associated with the actual inking gestures can be accessed and rendered on the user interface. In some embodiments, the user interface with the training information (e.g., specifically scoped training information) can be rendered when the user interface has not been presented before, after a time period has elapsed from the previous presentation, or upon new digital inking features becoming available within the application. In some embodiments, a first use of digital ink within the application can result in surfacing of the user interface with general digital ink training information highlighting the most frequently used gestures.

The foregoing Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Embodiments of the present technology will be described and explained through the use of the accompanying drawings in which:

FIG. 1 illustrates a computing system and related operational scenarios in accordance with various embodiments of the present technology.

FIG. 2 is a flow chart illustrating an example of a set of operations for automatically surfacing a user interface presenting new inking gestures according to some embodiments of the present technology.

FIG. 3 is a flow chart illustrating an example of a set of operations for monitoring user proficiency with inking gestures and automatically surfacing a user interface with training information in accordance with one or more embodiments of the present technology.

FIG. 4 illustrates operations within various layers of a device according to various embodiments of the present technology.

FIG. 5 is a flow chart illustrating an example of a set of operations for using machine learning to determine when to automatically surface a user interface with training information in accordance with some embodiments of the present technology.

FIG. 6 illustrates various components within a training system that can be used to teach gesture-based ink interactions in accordance with one or more embodiments of the present technology.

FIG. 7 illustrates a computing system suitable for implementing the software technology disclosed herein, including any of the applications, architectures, elements, processes, and operational scenarios and sequences illustrated in the Figures and discussed below in the Technical Disclosure.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DISCLOSURE

Various embodiments of the present technology relate to digital inking technology. More specifically, some embodiments relate to use of intelligent scaffolding to teach gesture-based ink interactions. As more intelligence and power is introduced into digital inking features, devices and applications include more gestures and new ways of interacting. With all of the new gestures and ways of interactions, users often have difficulty learning and remembering new gestures. Traditionally, most help content is provided via comprehensive help articles on the web. These comprehensive articles are limited in the value provided since the amount of information can be overwhelming and the articles can be difficult to navigate. As such, interactions with the articles can cause issues by disrupting user workflow. Instead, users need quick access to a very scoped amount of data rather than access to paragraphs of descriptive content.

In contrast, various embodiments of the present technology introduce training techniques that work well with customer workflow and incorporate learning theory to help customers get better at using the gestures over time (e.g. through scaffolding). Some embodiments leverage the scaffolding learning methodology to teach users how to use ink gestures to complete productivity tasks. Scaffolding involves providing an appropriate level of support at different stages of the workflow to enable users to be successful in a task while helping them learn to use a set of skills independently. As such, users can be automatically presented with scoped content at the right points in the workflow to prevent disruption while still receiving useful and actionable information which is not possible with traditional, larger help articles that focus on all available features.

In accordance with some embodiments, when a user first uses improvements to an ink editor within an application, a help pane (or user interface) can be automatically surfaced to show the gestures that are available. As the user uses the ink editor, the user can reference the gestures as much as they would like. Over time, the pane (or user interface) can appear contextually only when needed. For example, if the user seems to be struggling with gestures, the pane (or user interface) can appear as a reminder to help the user complete a task. The pane (or user interface) can also intelligently remember state information over time (e.g., the system can determine when the user would prefer to always have the pane vs. have the pane be hidden). Having the pane (or user interface) appear consistently at the beginning, and then slowly reducing presence and only appearing when needed, mirrors the scaffolding learning technique used often in education to teach new concepts and skills. As such, various embodiments can effectively teach users new interaction models in various applications using ink gestures. These techniques can also be used for other features that require some level of longer-term learning to operate, making it scalable to the larger application ecosystems (e.g., Microsoft Office suite) as a way to sustainably teach user how to efficiently use produce features.

Various embodiments of the present technology provide for a wide range of technical effects, advantages, and/or improvements to computing systems and components. For example, various embodiments include one or more of the following technical effects, advantages, and/or improvements: 1) intelligent presentation of scoped content based on user interactions to efficiently teach ink-based gestures to users; 2) integrated use of scaffolding learning techniques to teach how to use software that has a learning curve; 3) proactive and gradual training effectively integrated into user workflow; 4) use of unconventional and non-routine computer operations to contextually provide help when user are struggling to complete a digital inking tasks; 5) cross-platform integration of machine learning to more efficiently scope and surface training tools; 6) changing the manner in which a computing system reacts to ink-based gestures; and/or 7) changing the manner in which a computing system reacts to user interactions and feedback.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to improving user interactions with ink-based gestures, embodiments of the present technology are equally applicable to various other features found within applications.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

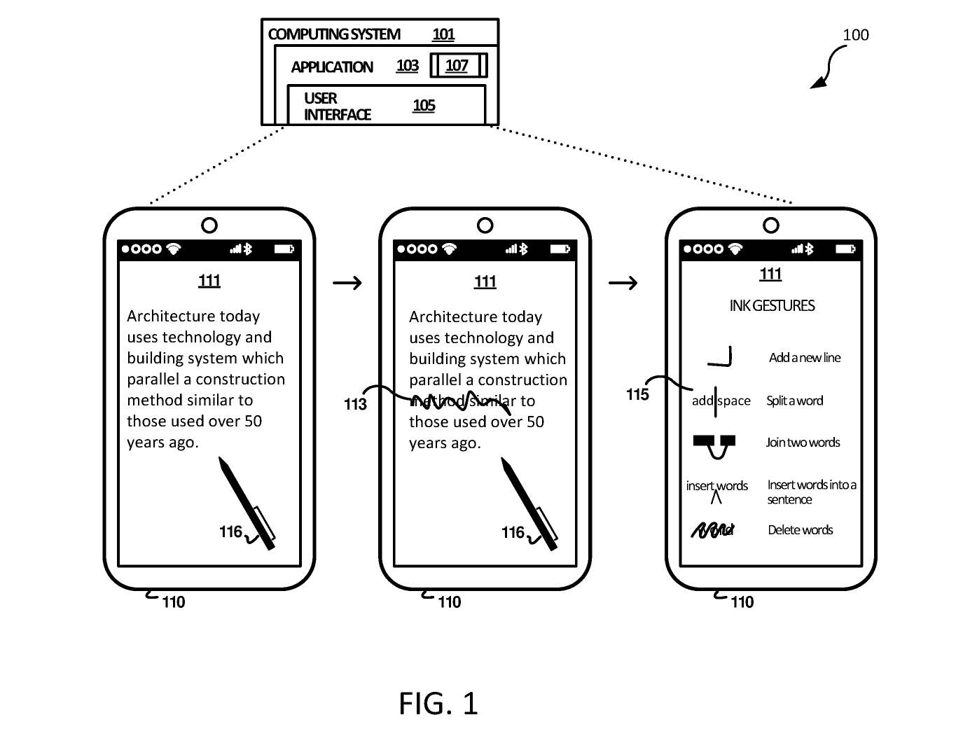

FIG. 1 illustrates a computing system and related operational scenarios 100 in accordance with various embodiments of the present technology. As illustrated in FIG. 1, computing system 101 can include application 103, which employs a training process 107 to produce scoped content on a user interface 105 in response to detection of various digital inking gestures and interactions. View 110 is representative a view that may be produced by application 103 in user interface 105.

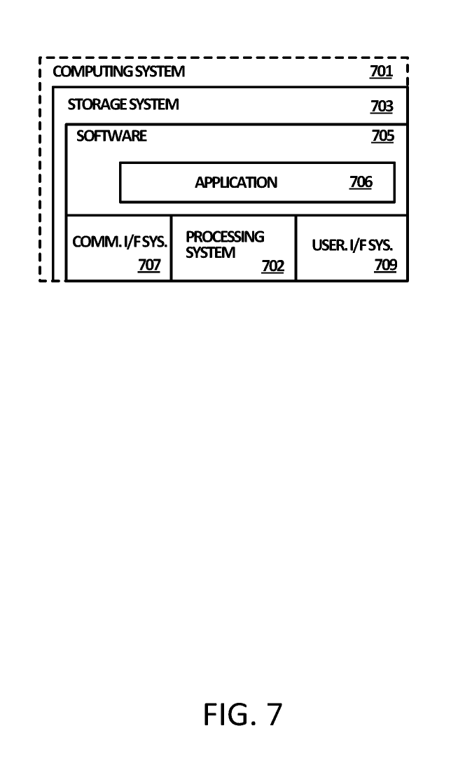

Computing system 101 is representative of any device capable of running an application natively or in the context of a web browser, streaming an application, or executing an application in any other manner Examples of computing system 101 include, but are not limited to, personal computers, mobile phones, tablet computers, desktop computers, laptop computers, wearable computing devices, or any other form factor, including any combination or variations thereof. Computing system 101 may include various hardware and software elements in a supporting architecture suitable for providing application 103. One such representative architecture is illustrated in FIG. 7 with respect to computing system 701.

Application 103 is representative of any software application or application component capable of supporting directional effects in accordance with the processes described herein. Examples of application 103 include, but are not limited to, presentation applications, diagraming applications, computer-aided design applications, productivity applications (e.g. word processors or spreadsheet applications), and any other type of combination or variation thereof. Application 103 may be implemented as a natively installed and executed application, a web application hosted in the context of a browser, a streaming application, a mobile application, or any variation or combination thereof.

View 110 is representative of a view that may be produced by application 103. View 110 includes an application view 111 on which a user may utilize a stylus to draw lines, shapes, objects, edit typed text, or supply hand-written words, for example. In some embodiments, application view 111 may present a canvas overlay in response to certain user interactions or gestures. The canvas overlay can provide a semi-transparent layer over application view 111 that can allow user to provide additional gestures. Stylus 116 is representative of one input instrument, although other instruments are possible, such as mouse devices and touch gestures, or any other suitable input device.

In operational scenario 100, application 103 monitor user interactions within application view 111. Application 103 can detect that user is using inking gestures. As illustrated in FIG. 1, the inking gesture could include striking gesture (or input stroke) 113 of text within the application indicating to application 103 that the text should be deleted. Application 103 can then automatically render a training interface 115, in view 110. Training interface 115 can offer scoped training material or information selected in response to detected user interactions within application 103.

For example, in accordance with some embodiments, when a user first uses digital inking within application 103, a help pane (or user interface) can be automatically surfaced to show the gestures (e.g., add a new line, split a word, join two words, insert words, delete words, insert comment, move, find and replace, etc.) that are available. As the user uses the ink editor mode (e.g., a mode that allows editing of a document or file with digital inking gestures that are translated into actions such as delete, find and replace, split words, and the like) within the application, the user can reference the gestures as needed. Over time, training interface 115 can automatically appear contextually only when application 103 determines additional training would benefit the user and would not interrupt current workflow. For example, if the user seems to be struggling with gestures (e.g., repeated gestures followed by undo operations, unrecognized gestures, transitions back into other editing modes, slow or below average gesture speed, etc.), training interface 115 can appear as a reminder to help the user complete a task.

In some embodiments, training interface 115 can also intelligently remember state activity over time (e.g., the system can determine when the user would prefer to always have the interface vs. have the interface be hidden). Training interface 115 may appear consistently at the beginning of use of an application or use of a digital pen, and then slowly appear less frequently unless new gestures become available or user proficiency issues are detected. The initial training may be more general (e.g., highlighting the most commonly used gestures) while later training may be less frequency and specifically scoped to help improve specific interactions with the user. By reducing presentation of training interface 115 over time, various embodiments can effectively teach users new interaction models in application 103 using ink gestures without creating undesired interruptions.

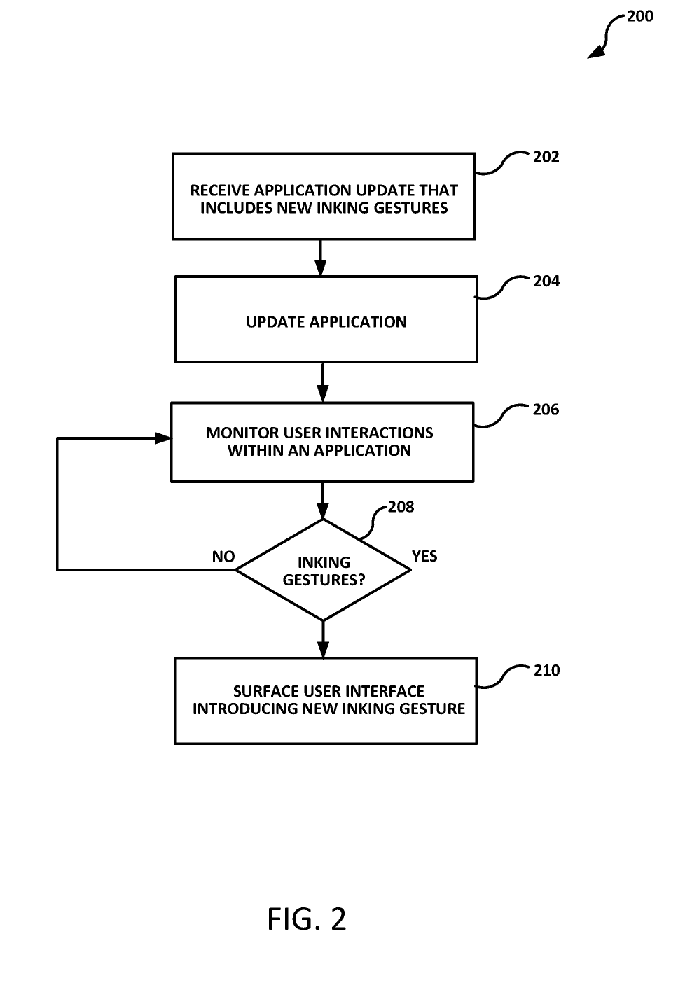

FIG. 2 is a flow chart illustrating an example of a set of operations 200 for automatically surfacing a user interface presenting new inking gestures according to some embodiments of the present technology. The operations illustrated in FIG. 2 can be performed by various components, modules, or devices including, but not limited to, user devices or cloud-based collaboration services hosting applications that can be accessed by user devices. As illustrated in FIG. 2, during receiving operation 202, application updates are received that include new inking gestures and the application is updated with update operation 204. During monitoring operation 206, telemetry data can be collected regarding the user interactions (e.g. keyboard strokes, undo requests, digital inking gestures, and the like) within an application. The telemetry data can include information about type and sequence of interactions. For example, this can be useful in detecting digital inking gesture follow-up by undo operations and/or keyboard or mouse input to finalize the operation. In some embodiments, the telemetry data may also include information about the document and/or application.

Determination operation 208 can analyze the telemetry data to identify whether any inking gestures are present. When determination operation 208 determines that no inking gestures are present, then determination operation can branch to monitoring operation 206 where more telemetry data can be collected. The telemetry data may be local in time (e.g., within the past week), a complete history of all interactions, or somewhere in-between. When determination operation 208 determines that inking gestures are present within the telemetry data, surfacing operation 210 can automatically (e.g., without a user request) surface a training user interface inducing new inking gestures. In some embodiments, surfacing operation 210 may suppress display of the training user interface until a similar action has been performed by the user via a non-gesture technique (e.g., keyboard and mouse inputs). Similarly, surfacing operation 210 may suppress surfacing of the training interface when the telemetry data indicates that an inking gesture is outside of a desired time period (e.g., current session, last week, etc.)

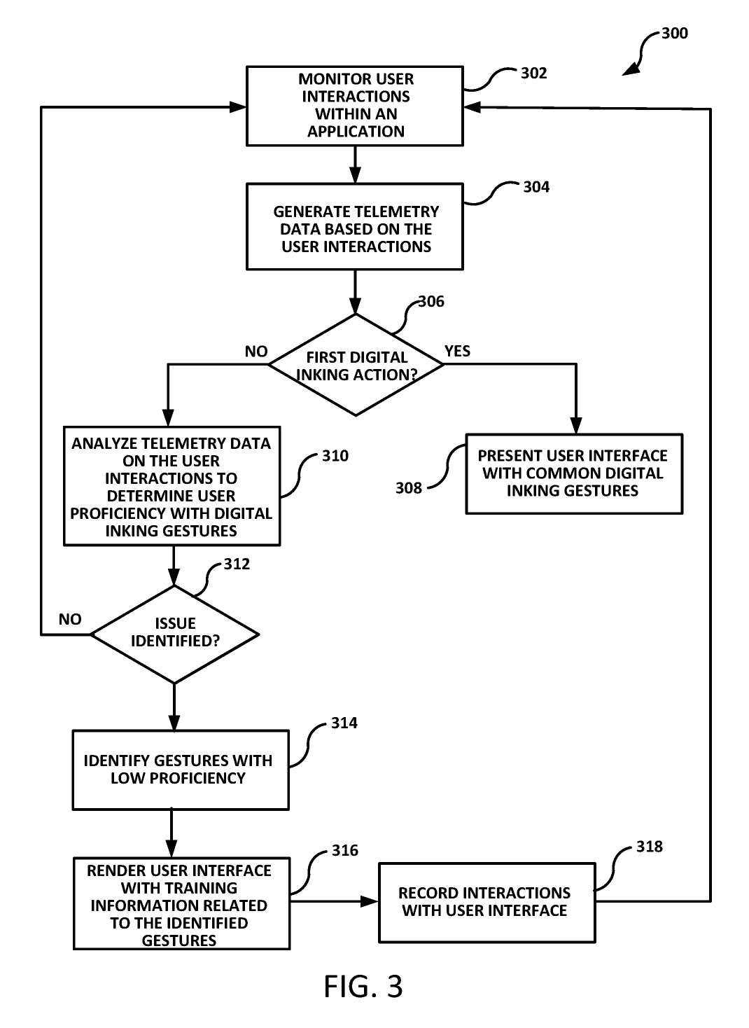

FIG. 3 is a flow chart illustrating an example of a set of operations 300 for monitoring user proficiency with inking gestures and automatically surfacing a user interface with training information in accordance with one or more embodiments of the present technology. The operations illustrated in FIG. 3 can be performed by various components, modules, or devices including, but not limited to, user devices or cloud-based collaboration services hosting applications that can be accessed by user devices. As illustrated in FIG. 3, monitoring operation 302 monitors user interactions within an application. Based on the user interactions detected by monitoring operation 302, generation operation 304 can generate telemetry data (e.g., data structures populated with information regarding user interactions).

Determination operation 306 can analyze the telemetry data and determine whether an identified user interaction is a first digital inking action. When determination operation 306 determines a first digital inking action is present, determination operation 306 can branch to presentation operation 308 where a training user interface with common digital inking gestures are present. In some embodiments, the common digital inking gestures presented may be scoped based on an analysis of common interactions of the user (e.g., highlighting, deleting words, etc.). In other embodiments, the common digital inking gestures may be the most frequency use of digital inking gestures across multiple users.

When determination operation 306 determines a digital inking action is not present, determination operation 306 can branch to analysis operation 310 where the telemetry data is analyzed to determine the proficiency of that user with digital inking gestures. When identification operation 312 determines that no proficiency issues has been identified, then identification operation 312 can branch to monitoring operation 302 where additional user interactions are monitored. When identification operation 312 identifies a proficiency issue, then identification operation 312 can branch to matching operation 314 where gestures (e.g., low proficiency ratings) used by the user are classified (e.g., using a machine learning classifier such as support vector machines or other technique) to identify actual gestures the user was attempting to execute.

Rendering operation 316 can render or surface a training user interface with specifically scoped training information related to the identified gesture(s) with low proficiency. Once the interface is surfaced on a display, recording operation 318 can monitor the interactions of the user with the training interface. For example, these interactions can include how quickly the user closes the training user interface, the amount of time spent practicing the gesture (e.g., on a canvas overlay), and the like. This information can be included as part of user interactions detected by monitoring operation 302. Moreover, some embodiments, can adjust how and when the training user interface is surfaced based on this information. These adjustments can be personalized for the specific user and generalized based on user interactions from multiple user across multiple devices and platforms.

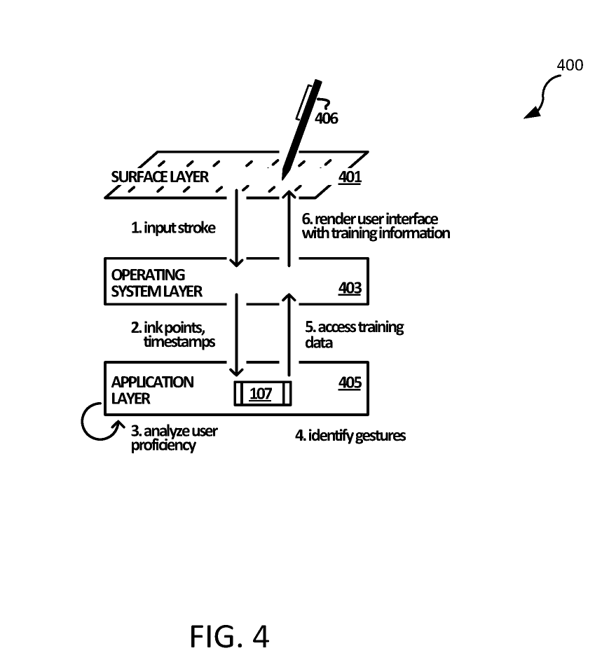

FIG. 4 illustrates operations within various layers of a device 400 according to various embodiments of the present technology. As illustrated in FIG. 4, the operational architecture of device 400 can includes surface layer 401, operating system layer 403, and application layer 405. Surface layer 401 is representative of any hardware or software elements that function to receive drawing input from an input instrument. Stylus 406 is representative of one such instrument.

Surface layer 401 can also display objects and user interfaces to a user. Operating system layer 403 is representative of the various software elements that receive input information from surface layer 401 in relation to the drawing input or gesture supplied by stylus 406. Operating system layer 403 may also handle some aspects of object rendering. Application layer 405 is representative of a collection of software elements that receive input information from operating system layer 403. Application layer 405 may also provide output information to operating system layer 403.

In the operational scenario illustrated in FIG. 4, input strokes or gestures supplied by stylus 406 is received by surface layer 401. The input strokes or gestures are communicated in some format to operating system layer 403. Operating system layer 403 informs application layer 405 about the input stroke in terms of ink points, timestamps, and possibly other path data.

Application layer 405, analyzes user proficiency with the input strokes. For example, application layer 405 can monitor for input stokes followed by undo requests as an indicator of low proficiency. As another example, application layer 405 may look for quality of stroke that is on an interpretation boundary as an indicator that proficiency may be able to be improved. Application layer 405 can identify actual gestures (e.g., using machine learning classifier or other technique) and use operating system layer 403 to access specific training data regarding that identified gesture. Operating system layer 403 can render a user interface with that specific training information to surface layer 401.

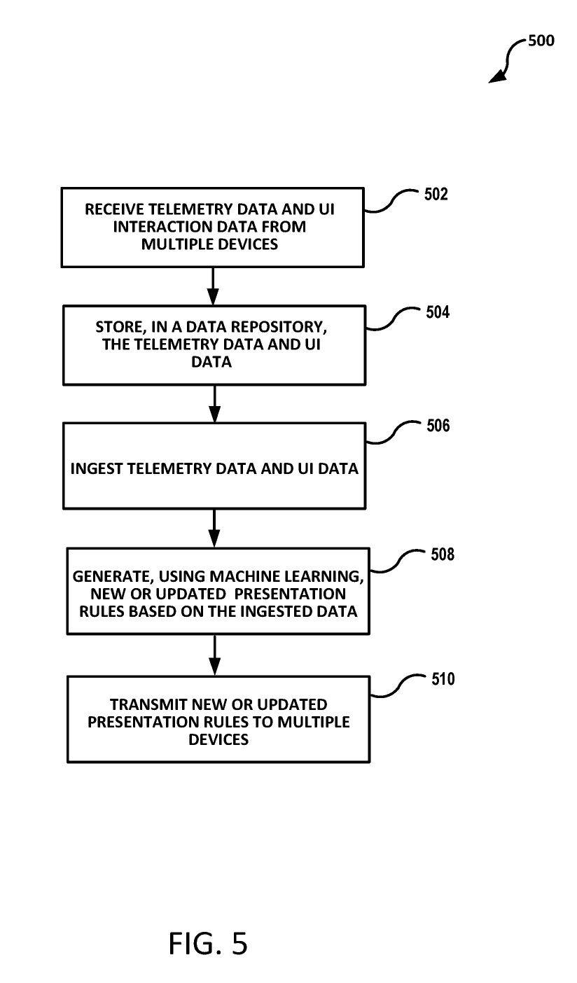

FIG. 5 is a flow chart illustrating an example of a set of operations 500 for using machine learning to determine when to automatically surface a user interface with training information in accordance with some embodiments of the present technology. The operations illustrated in FIG. 5 can be performed by various components, modules, or devices including, but not limited to, user devices or cloud-based collaboration services or analysis platforms. As illustrated in FIG. 5, receiving operation 502 can receive telemetry data and/or UI interaction data from multiple devices. Storing operation 504 can store, in a data repository, the telemetry and/or user interface interaction data obtained via receiving operation 502.

Ingestion operation 506 can ingest (e.g., via an ingestion engine) the telemetry and/or user interface interaction data. Ingestion operation 506 can ensure that data parameters fall within valid limits or ranges, data types, or structures. In some embodiments, ingestion operation can also format data, remove unwanted fields or data types, and the like. Using the ingested data, generation operation 508 can generate new or updated presentation rules. For example, every time a new feature is rolled out, data from the first group of respondents (e.g., 50k) or user within a specified time period (e.g., one week) may be ingested and analyzed to determine updated presentation rules. As such, the system can learn that for future users the training user interface may need to be surface later, soon, in response to different events, or with different training information. In accordance with various embodiments, this can be done with various supervised or unsupervised learning systems. Once identified, these new or updated rules can be propagated back to various client devices for implementation during transmission operation 510. In some embodiments, generation operation 508 may identify target rules for specific user populations having common characteristics or interaction patterns with digital inking gestures.

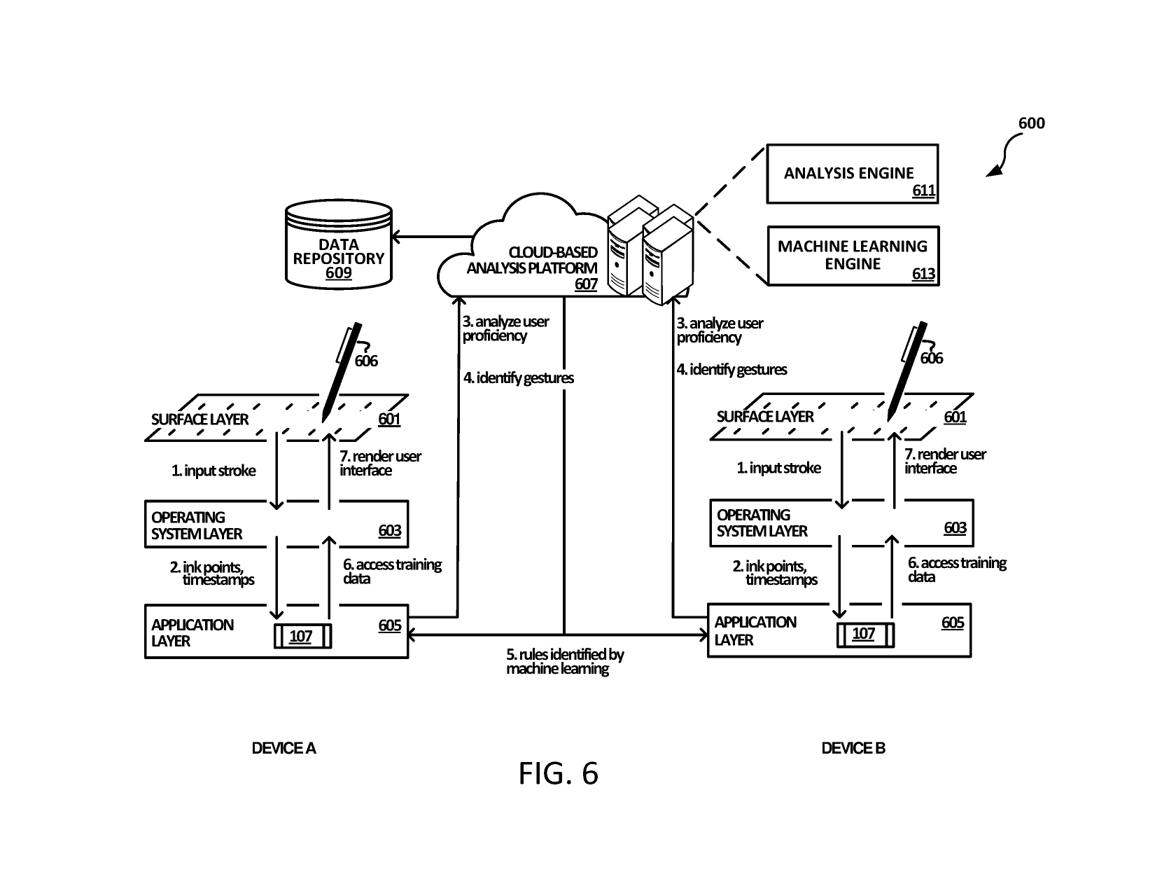

FIG. 6 illustrates various components 600 within a training system that can be used to teach gesture-based ink interactions in accordance with one or more embodiments of the present technology. As illustrated in FIG. 6, various devices can include different layers such as surface layer 601, operating system layer 603, and application layer 605. The devices can be connected to cloud-based analysis platform 607. Surface layer 601 can display objects and user interfaces to a user. Operating system layer 603 is representative of the various software elements that receive input information from surface layer 601 in relation to the drawing input or gesture supplied by stylus 606. Operating system layer 603 may also handle some aspects of object rendering. Application layer 605 is representative of a collection of software elements that receive input information from operating system layer 603. Application layer 605 may also provide output information to operating system layer 603.

In the operational scenario illustrated in FIG. 6, input strokes or gestures supplied by stylus 606 is received by surface layer 601. The input strokes or gestures are communicated in some format to operating system layer 603. Operating system layer 603 informs application layer 605 about the input stroke in terms of ink points, timestamps, and possibly other path data.

Application layer 605, transmits the data to analysis platform 607 which can be stored in data repository 609. Analysis engine 611 can analyze user proficiency (e.g., skill) with the input strokes. For example, analysis engine 611 can monitor for input stokes followed by undo requests as an indicator of low proficiency. As another example, analysis engine 611 may look for a quality of a stroke that is on an interpretation boundary as an indicator that proficiency may be able to be improved. Analysis engine 611 may also look at other factors including, but not limited to, the number of different gestures the user is accessing (e.g., a low number of different gestures being used may indicate a low proficiency), gesture or stroke speed, additional editing after transitioning out of an ink editor mode, and the like. Machine learning engine 613 can identify actual gestures (e.g., using machine learning classifier or other technique) that are similar to those detected as having low proficiency. An indication of the identified gestures can be transmitted back to the application and operating system layer 603 to access specific training data regarding that identified gesture. Operating system layer 603 can render a user interface with that specific training information to surface layer 601. In some embodiments, machine learning engine 613 can analyze groups of data to refine presentation rules for when to surface the training interface.

FIG. 7 illustrates computing system 701, which is representative of any system or collection of systems in which the various applications, architectures, services, scenarios, and processes disclosed herein may be implemented. Examples of computing system 701 include, but are not limited to, desktop computers, laptop computers, tablet computers, computers having hybrid form-factors, mobile phones, smart televisions, wearable devices, server computers, blade servers, rack servers, and any other type of computing system (or collection thereof) suitable for carrying out the directional effects operations described herein. Such systems may employ one or more virtual machines, containers, or any other type of virtual computing resource in the context of directional effects and digital inking.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes application 706 which is representative of the software applications discussed with respect to the preceding FIGS. 1-6, including application 103. When executed by processing system 702 to support directional effects in a user interface, application 706 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 in general, and application 706 in particular, may be implemented in program instructions and among other functions may, when executed by processing system 702, direct processing system 702 to operate as described with respect to the various operational scenarios, sequences, and processes illustrated herein. For example, application 706 may include program instructions for implementing a directional effects process, such as training process 107.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtual machine software, or other application software, in addition to or that include application 706. Software 705 may also comprise firmware or some other form of machine-readable processing instructions executable by processing system 702.

In general, application 706 may, when loaded into processing system 702 and executed, transform a suitable apparatus, system, or device (of which computing system 701 is representative) overall from a general-purpose computing system into a special-purpose computing system customized to perform directional effects operations. Indeed, encoding application 706 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, application 706 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 may include a keyboard, a stylus (digital pen), a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here.

User interface system 709 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface, in which a user interface to an application may be presented (e.g. user interface 105).

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and Figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
program instructions stored on the one or more computer readable storage media that, when executed by the processing system, direct the processing system to at least:
collect data on user interactions within an application;
analyze data on the user interactions to identify user proficiency with digital inking gestures within the application; and
render a user interface with training information to improve the user proficiency with digital inking gestures.

2. The computing apparatus of claim 1, wherein the user interactions with the user interface collected in the data includes repeated inking gestures followed by undo requests and wherein to analyze the data, the program instructions direct the processing system to:
identify the repeated inking gestures followed by the undo requests;
analyze the repeated inking gestures to identify actual inking gestures supported by the application that are similar to the repeated inking gestures; and
access the training information associated with the actual inking gestures to be rendered on the user interface.

3. The computing apparatus of claim 1, wherein the program instructions further direct the processing system to recognize failed digital inking gestures and analyze the failed digital inking gestures to identify, using a machine learning classifier, actual inking gestures resembling a digital inking feature within the application.

4. The computing apparatus of claim 1, wherein the program instructions further direct the processing system to render the user interface with the training information when the user interface has not been presented before, after a time period has elapsed from previous presentations of the user interface, or upon new digital inking features becoming available within the application.

5. The computing apparatus of claim 1, wherein the user interactions are collected upon detection of the application entering a ink editing mode allowing ink gestures to be translated into editing commands and wherein the data includes keyboard interactions, mouse interactions, inking gestures, and digital pen interactions with the user interface to the application.

6. The computing apparatus of claim 1, wherein the program instructions direct the processing system to determine whether the user interactions include a first use of digital ink within the application and surface the user interface with general digital ink training information.

7. The computing apparatus of claim 1, wherein the program instructions direct the processing system to record interactions with the user interface and transmit the data and interactions with the user interface to a cloud-based data repository to be ingested by a machine learning system, along with other data and interactions with additional user interfaces, to determine rules regarding when to render the user interface.

8. A method comprising:
collecting, at a client device, telemetry data on user interactions with a user interface to an application;
analyzing telemetry data on the user interactions to identify user proficiency with a digital inking gesture;
identifying, upon determining a low user proficiency with the digital inking gesture, user interactions resembling a digital inking gesture within the application; and
automatically surfacing, on a display of the client device, a user interface with training information on the digital inking gesture to improve the user proficiency with digital inking gesture.

9. The method of claim 8, wherein the user interactions with the user interface collected in the telemetry data include repeated inking gestures followed by undo requests and wherein to analyzing the telemetry data to identify user proficiency includes:
identifying the repeated inking gestures followed by the undo requests; and
analyzing the repeated inking gestures to identify the digital inking gesture supported by the application that are similar to the repeated inking gestures.

10. The method of claim 9, wherein analyzing the repeated inking gestures to identify the digital inking gesture within the application using a machine learning classifier.

11. The method of claim 9, further comprising
retrieving the training information associated with the digital inking gesture to be rendered on the user interface; and
wherein the user interface is automatically surfaced only if the user interface has not been presented before, after a time period has elapsed from a previous presentation of the user interface, or upon new digital inking features becoming available within the application.

12. The method of claim 8, wherein the user interactions collected by the telemetry data include keyboard interactions, mouse interactions, inking gestures, and digital pen interactions with the user interface to the application.

13. The method of claim 8, further comprising analyzing the telemetry data to determine whether the user interactions include a first use of digital ink within the application, and upon determining a first use, automatically surfacing the user interface with general digital ink training information.

14. The method of claim 8, further comprising:
recording interactions with the user interface; and
transmitting the telemetry data and interactions with the user interface to a cloud-based data repository to be ingested by a machine learning system, along with other telemetry data and interactions with additional user interfaces, to determine rules regarding when to automatically surface the user interface.

15. The method of claim 14, further comprising:
receiving, at the client device, the rules regarding when to automatically surface the user interface; and
updating the application with the rules.

16. One or more computer readable storage media having program instructions stored thereon for supporting digital inking training that, when executed by one or more processor, direct a machine to at least:
monitor user interactions with a user interface to an application;
analyze the user interactions to identify user proficiency with digital inking gestures or to identify user interactions resembling a digital inking feature within the application; and
automatically render a user interface with training information to improve the user proficiency with digital inking gestures or to train on use of the digital inking feature.

17. The one or more computer readable storage media of claim 16, wherein to analyze the user interactions to identify a digital inking feature, the machine uses a machine learning classifier.

18. The one or more computer readable storage media of claim 16, wherein the program instructions further cause the machine to record interactions with the user interface and transmit the user interactions and interactions with the user interface to a cloud-based analysis platform to be ingested by a machine learning system to determine rules regarding when to render the user interface.

19. The one or more computer readable storage media of claim 17, wherein the program instructions further cause the machine to determine whether the user interactions include a first use of digital ink within the application and automatically render the user interface with digital ink training information that includes most commonly used gestures.

20. The one or more computer readable storage media of claim 17, wherein the program instructions further cause the machine to suppress automatically rendering the user interface when a time period has not elapsed from a previous automatic rendering of the user interface.
